(19) United States
(12) Patent Application Publication
(10) Pub. No.: US 2005/0153103 A1
(43) Pub. Date: Jul. 14, 2005

(54) Fire retardant roofing tile

(76) Inventors: Lyle Meyer, West Liberty, IA (US); Gerald Edson, Terre Haute, IN (US)

Correspondence Address: DANIEL J. O'CONNOR, #821, 6720 BUCKHORN DR, INDIANAPOLIS, IN, 46254, US

(21) Appl. No.: 10/719,837

(22) Filed: Nov. 24, 2003

(51) Int. Cl. B32B 3/00

(52) U.S. Cl. 428/156; 428/167

(57) ABSTRACT

A fire resistant roofing tile which utilizes economical materials and is formed using an efficient manufacturing technique. The tile has components shaped to prevent fire spread significantly enough to achieve a Class A fire retardation rating. Recycled materials are used in a compression molding process for commercial appeal and benefit to the ecology.

### BACKGROUND AND OBJECTS OF THE INVENTION

The present invention is generally related to the covering arts and, in particular, to a roofing tile which is highly fire resistant.

Prior art designs have required relatively expensive compositions to achieve a Class A degree of fire protection.

A “Class A” fire resistance rating is defined by The Department of Fire Technology-Southwest Research Institute as follows:
Class A tests are applicable to roof coverings that are effective against severe test exposure, afford a high degree of fire protection to the roof deck, do not slip from position and do not present a flying brand hazard.

Accordingly, it is an object of the present invention to set forth a roofing tile which is very economically made and which is also able to achieve a Class A fire resistance rating.

It is also an object of the invention to demonstrate a roofing tile or roof covering which may be compression molded in an economical manufacturing process.

The roofing tile manufacturing process is able to utilize economical recycled materials such as rubber and plastics in a novel composition.

It is a further object of the invention to show a novel ribbed structure as a part of a roofing tile which produces a high degree of flame resistance and fire retardation.

These and other objects of the invention will be apparent to those of skill in the art from the description which follows.

### PRIOR ART PATENTS AND DESIGNS

U.S. Pat. No. 6,194,519 issued in 2001 teaches the use of recycled rubber products such as automobile tires in a roofing shingle product. The design is not apparently able to achieve a high fire retardant rating.

U.S. Pat. No. 6,021,611 issued in 2000 teaches the use of a shingle with ribs formed thereon. Such rib and cavity formation is apparently used only for nailing and construction purposes and requires costly materials and manufacturing processes to produce the product.

In contrast, the present invention uses a specially designed rib and flow configuration to produce the highest degree(Class A) of fire retardation. The roofing tiles disclosed are very economically manufactured in a compression molding process which reduces machine and labor costs.

### SUMMARY OF THE INVENTION

A roofing tile which is on the order of 7 inches by 23 inches includes a plurality of ribs which are arranged in a particular crossing pattern.

The ribs form various compartments from the top to the bottom of the roofing tile.

The compartments increase in depth progressively from top to bottom. Such structure results in increasing capture of burned materials and thus retards fire spread in an effective manner.

Thus, very economical materials such as recycled rubber and plastics can be used to compose the roofing tile.

Various sizes and dimensions of the disclosed tiles can be utilized depending upon the particular application.

### BRIEF DESCRIPTION OF THE DRAWING FIGURES

FIG. 1 is a top view of the roofing tile or roof covering material and shows the various chambers which are formed via the cross-ribbed configuration.

FIG. 2 is a side view of the roofing tile along lines 2-2 of FIG. 1. In FIG. 2, the progressive increase in depth of the ribs to provide increasing compartment volume is shown.

FIG. 3 shows a schematic view of the broader and distinct method aspects of the invention which has application to the collection of various flame-melted and hazardous materials.

### FULL DESCRIPTION OF A PREFERRED EMBODIMENT

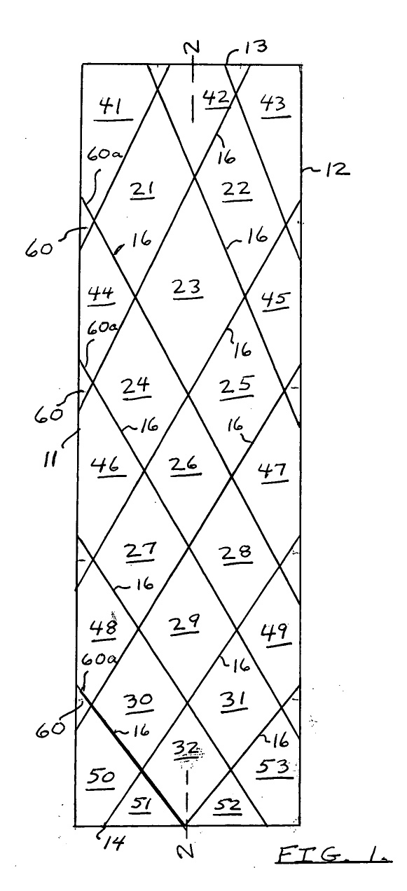

Referring to the drawing FIG. 1, a roofing tile or covering material is indicated at numeral 10.

The tile shown is on the order of seven inches by twenty-three inches but various sizes may of course be utilized.

Tile 10 has lateral sides 11 and 12 and top and bottom edges 13 and 14 respectively.

A plurality of ribs 16 are formed as a part of the tile 10 in a compression molding process. A total of twelve ribs are shown in FIG. 1.

As indicated, the ribs 16 form a number of diamond or parallelogram shaped compartments shown at numerals 21-32. These compartments 21-32 increase in depth from top to bottom for reasons to be further described. Lateral sides 11 and 12 also increase in depth from top to bottom.

As further shown in FIG. 1, the particular pattern of ribs 16 also forms compartments 41-53.

These compartments 41-53 are generally shaped as a portion of a diamond or parallelogram shape. Each of the compartments shown in FIG. 1 is generally elongated from top to bottom to promote a generally downward flow.

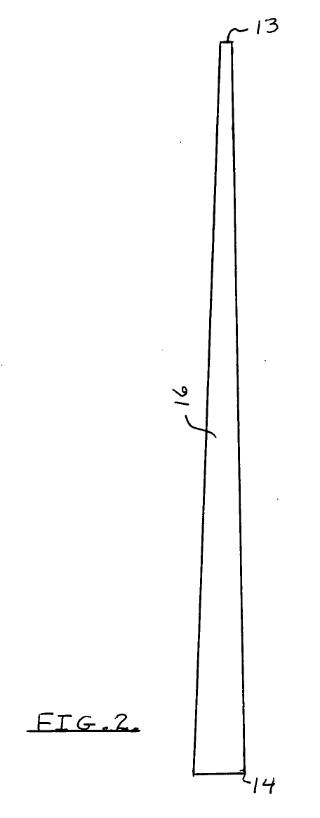

The side sectional view of FIG. 2 shows the top and bottom portions 13 and 14 of the tile 10.

FIG. 2 further shows the increasing depth of ribs 16 from top to bottom. In a typical model, the rib depth would be on the order of one-tenth inch at the top area 13 and would progressively increase to a depth of four-tenths inch at the bottom portion 14.

As noted, such configuration results in a progressively increasing volume of chambers 21-32 and chambers 41-53 from top to bottom.

Referring back to FIG. 1, the crossing rib configuration forms smaller triangular-shaped sections 60. Each of these sections 60 has a top wall 60a which tends to direct burned materials downwardly and toward the center of tile 10. Thus, flame spread from tile to tile is reduced and significantly retarded.

Thus, in operation of the overall device under a fire or flame condition, burned materials flow downwardly into progressively larger compartments. Such produces a glazing effect and retards flow of burning materials to other tiles and other areas of a structure.

The tile shape disclosed has been tested and given a Class A fire retardation rating, i.e. highest possible rating, by the Department of Fire Technology—Southwest Research Institute in a 2001 test report project number 01.04019.01.410a. Such test report is incorporated herein by reference and is available upon request.

In a very important economical aspect of the invention, the tile shape disclosed enables recycled materials to be used in a compression molding process. Compression molding machines and systems are much more economical than injection molding systems which are widely used in the art.

Thus, a superior product is produced at a significantly lower cost for widespread commercial appeal in the art.

The invention is also very helpful for the ecology since materials which typically are disposed of in landfills can be re-used in a long-life and fire retarding roofing shingle.

While a particular tile configuration and design has been shown and described, it is intended in this specification to cover all equivalent designs and methods which would reasonably occur to those of skill in the art.

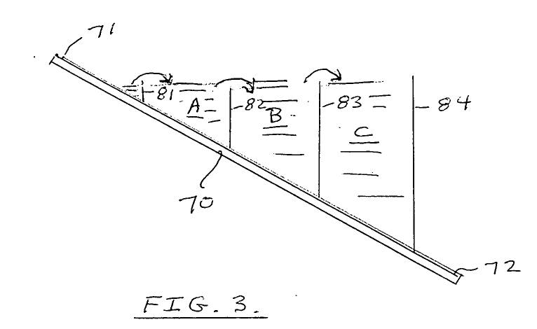

Referring to FIG. 3, the broader and distinct method aspects of the invention are shown.

A base 70 having an upper end 71 and a lower end 72 is shown. Plural raised ribs 81-84 are shown. As shown, chambers A, B and C are formed and are of increasing volume moving down the collection crevice.

The structure and method thus creates a trickle-down effect wherein the material is collected in larger and larger volumes to prevent the rapid spread of flame-melted or hazardous materials.

The invention thus suggests the broader method of collecting various materials to delay the undesired spread and reduce damage to property and personell.

Through lengthy experimentation, applicant has found that the following combination of elements is highly effective for use in a compression molding process to produce the desired roofing tile:
EPDM(ethylene propylene diene monomers), scrap from rubber seals or car parts and
SBR(styrene butadiene rubber), up to 50% by weight,
EVA(ethylene vinyl acetate) and ULDPE(ultra low density polyethylene) at 10-20% by weight,
ATH(aluminum tri-hydrate), fire retardant at 35% by weight in combination with 4% by weight zinc oxide,
HDPE(high density polyethylene at 10-30% by weight.

In practice, a red clay coloring is added at the time of blending.

The mixture is extruded and the extruded mass is placed into a water cooled compression mold producing the desired roofing tile product. Importantly, the above compound allows the use of compression molding rather than the more complex injection molding processes.

1. A roofing tile comprising:
a generally rectangular element (10) having lateral edges (11,12) and top and bottom portions (13,14),
wherein one side of said tile has a plurality of ribs (16) formed thereon,
wherein said ribs increase in depth from the top portion of the tile to the bottom portion of said tile,
wherein said ribs are formed in a generally crossing pattern and form means whereby compartments (21-32) are present and comprise increasing volumes from top to bottom,
the tile providing means whereby fire or flame spread is significantly reduced.

2. The roofing tile of claim 1 wherein said ribs are shaped to form diamond or partial diamond patterns to reduce flame spread.

3. The roofing tile of claim 2 wherein smaller triangular areas (60) are formed at lateral edges of the tile, said triangular areas (60) having upper portion means (60a) for directing a flame-melted material to a center portion of said tile.

4. A method of delaying the spread of flame-melted or hazardous materials comprising the steps of:
1) providing a base element (70) having upper and lower portions (71,72),
2) providing rib elements (81-84) extending from said base element (70),
3) collecting hazardous material in chambers (A,B,C) of progressingly increasing volume moving down the base element (70).
